(19) United States
(12) Patent Application Publication
(10) Pub. No.: US 2018/0339466 A1
(43) Pub. Date: Nov. 29, 2018

(54) MATERIAL HANDLING IN ADDITIVE MANUFACTURING

(71) Applicant: DIVERGENT TECHNOLOGIES, INC., Los Angeles, CA (US)

(72) Inventors: Eahab Nagi EL NAGA, Topanga, CA (US); John Russell BUCKNELL, El Segundo, CA (US); Kevin Robert CZINGER, Santa Monica, CA (US)

(21) Appl. No.: 15/607,055

(22) Filed: May 26, 2017

(51) Int. Cl. B29C 67/00; B22F 1/00

(52) U.S. Cl. CPC B29C 67/0077; B22F 8/00; B22F 1/0088

(57) ABSTRACT

Systems and methods for material handling in additive manufacturing systems are provided. Environmental control can decrease exposure of a powder to substances that change a material property of the powder and/or that change a property of a build piece formed from fusing the powder. Powders can be mixed for use in PBF systems. For example, a powder that has been through a printing operation can be reused by mixing the reuse powder with new powder. Powder can be recovered after a printing operation and reused, recycled into new powder, etc. Powder can be decontaminated for better reusability.

### BACKGROUND

### Field

The present disclosure relates generally to Additive Manufacturing systems, and more particularly, to material handling in Additive Manufacturing systems.

### Background

Additive Manufacturing (“AM”) systems, also described as three-dimensional (“3-D”) printer systems, can produce structures (referred to as build pieces) with geometrically complex shapes, including some shapes that are difficult or impossible to create with conventional manufacturing processes. AM systems, such as powder-bed fusion (“PBF”) systems, create build pieces layer-by-layer. Each layer or ‘slice’ is formed by depositing a layer of powder and exposing portions of the powder to an energy beam. The energy beam is applied to melt areas of the powder layer that coincide with the cross-section of the build piece in the layer. The melted powder cools and fuses to form a slice of the build piece. The process can be repeated to form the next slice of the build piece, and so on. Each layer is deposited on top of the previous layer. The resulting structure is a build piece assembled slice-by-slice from the ground up.

In some cases, substances found in the atmosphere can change one or more material properties of powder used in PBF systems. For example, some metal powders used in PBF systems can react with water, oxygen, and other substances in the atmosphere. Exposure to water in the atmosphere (e.g., humidity) and oxygen can change a material property of some powders by oxidizing the powder material, e.g., oxidizing an iron powder by turning the iron into iron oxide. In this case, the material property that is changed is a chemical property of the powder material. In another example, humidity can physically change some powders, e.g., by causing the powder to moisten and clump together, thus reducing the ability of the powder to flow through pipes, openings, etc. In this case, the material property that is changed is a physical property of the bulk powder, e.g., the flowability of the bulk powder, which may be the result of changes to multiple material properties that affect the flowability.

### SUMMARY

Several aspects of apparatuses and methods for material handling in AM systems will be described more fully hereinafter.

In various aspects, an apparatus for transporting metal powder can include a chamber, a transporter that transports the metal powder through the chamber, and an environmental system that creates an environment in the chamber that decreases exposure of the metal powder to a substance that changes a material property of the metal powder.

In various aspects, an apparatus for a powder-bed fusion system can include a chamber, a transporter that transports the metal powder through the chamber, and a vacuum pump connected to the chamber.

In various aspects, an apparatus for a powder-bed fusion system can include a chamber, a transporter that transports the metal powder through the chamber, an inert gas system that injects an inert gas into the chamber.

In various aspects, an apparatus for transporting metal powder can include a chamber, a transporter that transports the metal powder through the chamber, and an environmental system that creates an environment in a chamber that decreases exposure of the metal powder to a substance that causes a property of a build piece formed from fusing the metal powder to be different than the property of a build piece formed from fusing metal powder not exposed to the substance.

In various aspects, an apparatus for a powder-bed fusion system can include a first chamber that accepts a first metal powder and a second metal powder, a second chamber connected to the first chamber, and a dose controller that controls a dose of the second metal powder from the second chamber into the first chamber based on a characteristic of at least the first metal powder or the second metal powder.

In various aspects, an apparatus for a powder-bed fusion system can include a chamber that accepts a metal powder from the powder-bed fusion system, the chamber including a first port and a second port, a powder characterizer that determines a characteristic of the metal powder, a controller that determines whether to reuse the metal powder based on the characteristic, and a powder transporter that transports the metal powder through the first port if the controller determines the metal powder should be reused and that transports the metal powder through the second port if the controller determines the metal powder should not be reused.

In various aspects, an apparatus for a powder-bed fusion system can include a chamber that accepts a metal powder from the powder-bed fusion system, a decontamination system that decontaminates the metal powder, and a powder transporter that transports the metal powder into the chamber and that transports the decontaminated metal powder out of the chamber.

In various aspects, an apparatus for a powder-bed fusion system can include a powder-bed fusion apparatus that creates three-dimensional printed structures by fusing metal powder, and a metal atomizer connected to the PBF apparatus. The metal atomizer can create the metal powder from one or more metal sources including recycled three-dimensional printed structures. The metal atomizer can include, for example, a metal atomizer that heats and melts the metal from the metal sources and an atomization system that atomizes the liquid metal to form metal powder.

In various aspects, a method for transporting metal powder in a chamber can include creating an environment in the chamber that decreases exposure of the metal powder to a substance that changes a material property of the metal powder, and transporting the metal powder through the chamber.

In various aspects, a method for transporting metal powder in a chamber can include creating a vacuum in the chamber, and transporting the metal powder through the vacuum in the chamber.

In various aspects, a method for transporting metal powder in a chamber can include injecting an inert gas into the chamber, and transporting the metal powder through the inert gas in the chamber.

In various aspects, a method for transporting metal powder can include creating an environment in a chamber that decreases exposure of the metal powder to a substance that causes a property of a build piece formed from fusing the metal powder to be different than the property of a build piece formed from fusing metal powder not exposed to the substance, and transporting the metal powder through the chamber.

In various aspects, a method for a powder-bed fusion system can include accepting a first metal powder into a first chamber, and dosing a second metal powder into the first chamber from a second chamber connected to the first chamber based on a characteristic of at least the first metal powder or the second metal powder.

In various aspects, a method for a powder-bed fusion system can include accepting a metal powder from the powder-bed fusion system into a chamber, the chamber including a first port and a second port, determining a characteristic of the metal powder, determining whether to reuse the metal powder based on the characteristic, and transporting the metal powder through the first port in response to the determination to reuse the metal powder and transporting the metal powder through the second port in response to the determination not to reuse the metal powder.

In various aspects, a method for a powder-bed fusion system can include accepting a metal powder from the powder-bed fusion system into a chamber, decontaminating the metal powder in the chamber, and transporting the decontaminated metal powder out of the chamber.

In various aspects, a method for powder-bed fusion can include creating three-dimensional printed structures by fusing metal powder, and creating the metal powder from one or more metal sources including recycled three-dimensional printed structures.

Other aspects will become readily apparent to those skilled in the art from the following detailed description, wherein is shown and described only several embodiments by way of illustration. As will be realized by those skilled in the art, concepts herein are capable of other and different embodiments, and several details are capable of modification in various other respects, all without departing from the present disclosure. Accordingly, the drawings and detailed description are to be regarded as illustrative in nature and not as restrictive.

### BRIEF DESCRIPTION OF THE DRAWINGS

Various aspects of will now be presented in the detailed description by way of example, and not by way of limitation, in the accompanying drawings, wherein:

FIGS. 1A-D illustrate an example PBF system during different stages of operation.

FIG. 2 illustrates an exemplary apparatus for transporting metal powder.

FIG. 3 illustrates an exemplary apparatus for transporting metal powder in an inert gas environment.

FIG. 4 illustrates an exemplary apparatus for transporting metal powder in a vacuum environment.

FIG. 5 illustrates an exemplary apparatus for transporting metal powder.

FIG. 6 is a flowchart of an exemplary method of transporting metal powder in a chamber.

FIG. 7 illustrates an exemplary apparatus that can mix two metal powders for a PBF system.

FIG. 8 illustrates another exemplary apparatus that can mix two metal powders for a PBF system.

FIG. 9 is a flowchart of an exemplary method of mixing metal powder for a PBF system.

FIG. 10 illustrates another exemplary apparatus that can mix two metal powders for a PBF system.

FIG. 11 illustrates an exemplary powder recovery system for a PBF system.

FIG. 12 is a flowchart of an exemplary method of recovering metal powder in a PBF system.

FIG. 13 illustrates an exemplary powder decontamination system for a PBF system.

FIG. 14 is a flowchart of an exemplary method of decontaminating powder in a PBF system.

FIG. 15 illustrates an exemplary PBF system that includes powder reusing and recycling with environmental control.

FIG. 16 illustrates an exemplary powder recycling ecosystem.

FIG. 17 is a flowchart of an exemplary method of powder recycling in a powder recycling ecosystem.

### DETAILED DESCRIPTION

The detailed description set forth below in connection with the appended drawings is intended to provide a description of various exemplary embodiments of the concepts disclosed herein and is not intended to represent the only embodiments in which the disclosure may be practiced. The term “exemplary” used in this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

This disclosure is directed to material handling in AM systems, such as powder-bed fusion (PBF) systems. In particular, various exemplary embodiments are presented to illustrate aspects of decreasing exposure of a powder to substances that change a material property of the powder and/or that causes a property of a build piece formed from fusing the powder to be different than the property of a build piece formed from fusing powder not exposed to the substance. In some cases, the property of the build piece can be a material property. The term “substance” should be understood to refer to a physical substance. In this regard, electromagnetic waves (e.g., visible light), acoustic waves (e.g., sound waves), and thermal energy (e.g., thermal radiation, thermal conduction), etc., are not substances as that term is used herein.

Exposure of powder to some substances can reduce the powder's effectiveness for use in a PBF system. For example, oxygen in the atmosphere can oxidize some powder materials, which can add alloying agents that can reduce material performance parameters of build pieces. Furthermore, oxidation of the powder material can result in build pieces with coarser microstructure, which can reduce the quality of build piece. In another example, exposure of the powder to atmospheric water, i.e., humidity, can reduce the powder's effectiveness in a PBF system. Humidity can cause powder to clump together due to moisture condensing in between the grains of powder. Clumped powder can more easily clog various parts of the PBF system, such as augers and pipes.

Various exemplary embodiments are presented to illustrate aspects of mixing powders for use in PBF systems. For example, a powder that has been through a printing operation can be reused by mixing the reuse powder with new powder. In particular, if the reuse powder has a low level of contamination from the printing operation, the reuse powder may be mixed with a low percentage of new powder to be reused. On the other hand, if the reuse powder has a high level of contamination from the printing operation, the reuse powder may need to be mixed with a higher percentage of new powder. In various exemplary embodiments, the reuse powder can be dosed into a chamber of new powder, for example, based on a characteristic of the reuse powder, such as a level of contamination.

Various exemplary embodiments are presented to illustrate aspects of recovering powder after a printing operation. For example, a chamber positioned below the PBF apparatus can accept the metal powder that has not been fused after the printing operation. The chamber can include a characterizer that can determine a characteristic of the powder, such as a level of contamination. If the level of contamination is too high for reuse, the powder can be dumped through a first port in the chamber that leads to a recycling system that can, for example, melt the powder and create new powder from the liquid metal. If the level of contamination is not too high, the powder can be dumped through a second port that leads to a system that reuses the powder in the PBF apparatus. For example, the powder can be mixed with new powder as described in the paragraph above.

Various exemplary embodiments are presented to illustrate aspects of decontaminating powder. For example, a decontamination system can decontaminate powder that is going to be reused in the PBF apparatus. The decontamination system can include, for example, a furnace that heats the powder to decrease contaminants without melting the powder.

Furthermore, a powder recycling ecosystem can be created to recycle three-dimensional printed structures to create new powder for the PBF apparatus.

In many applications, the systems and methods disclosed herein can be implemented to reduce cost for PBF manufacturers and to reduce environmental impact of PBF manufacturing, thereby providing a more sustainable manufacturing platform for 3-D printed products.

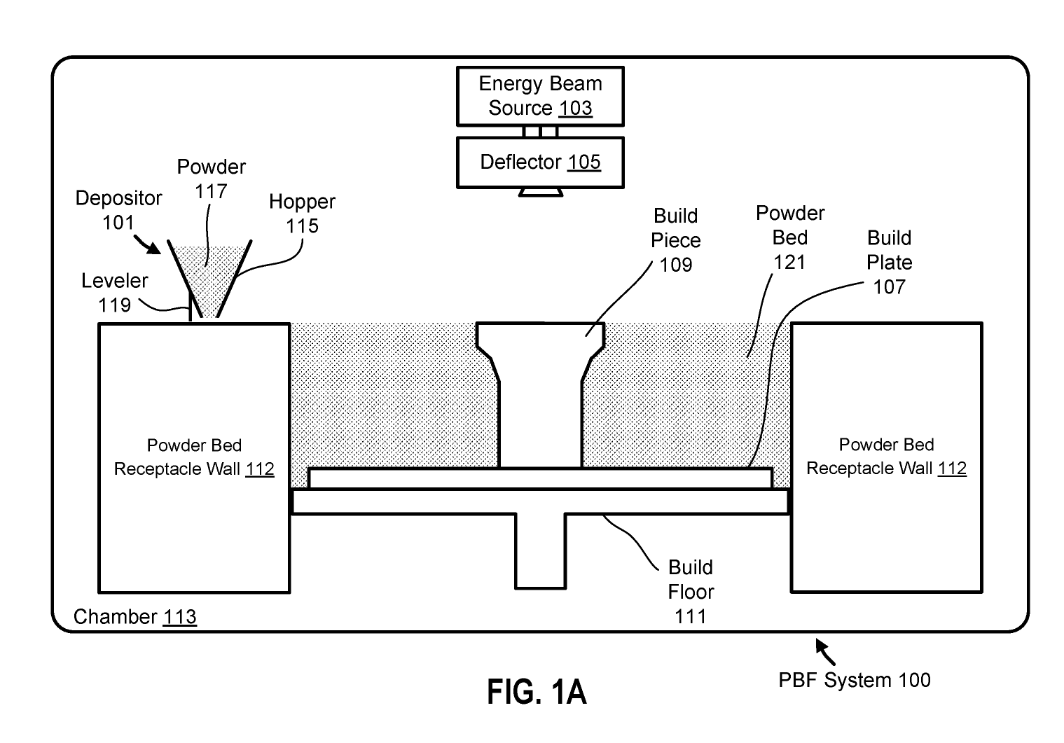

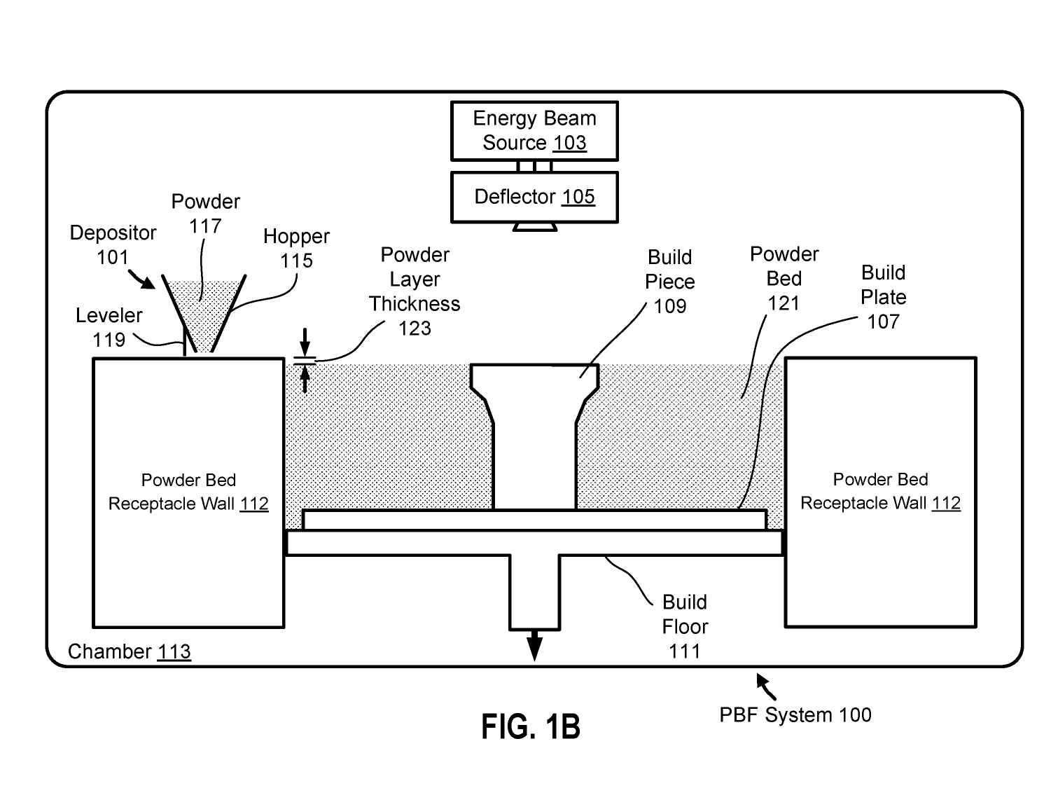

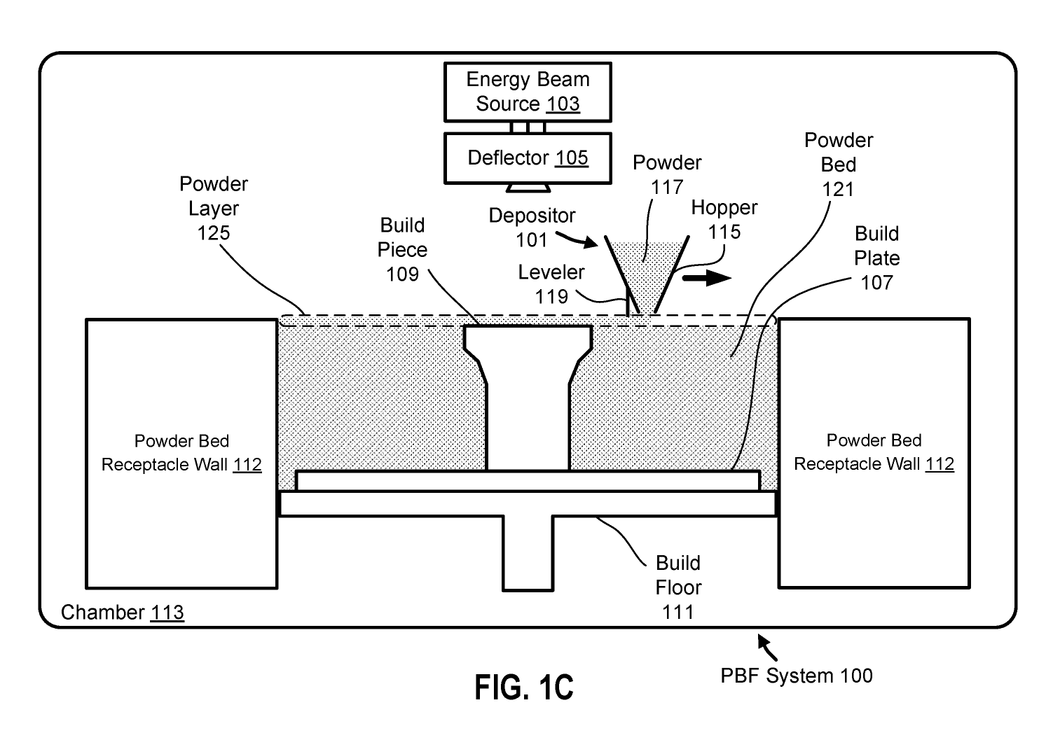

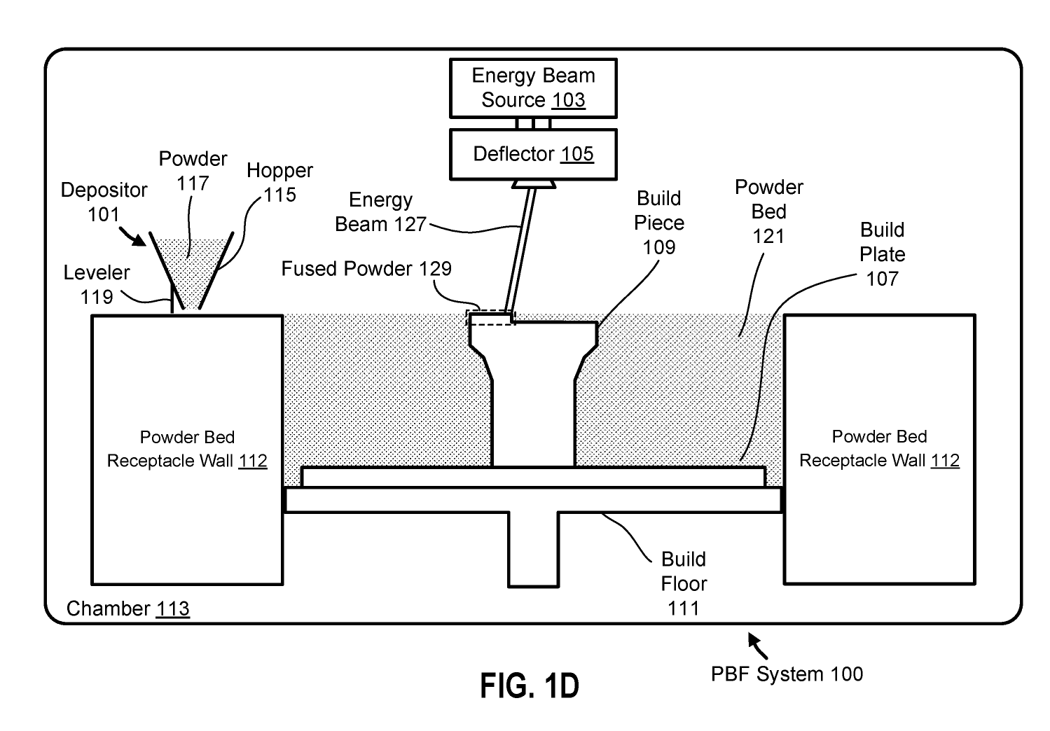

FIGS. 1A-D illustrate respective side views of an exemplary PBF system 100 during different stages of operation. As noted above, the particular embodiment illustrated in FIGS. 1A-D is one of many suitable examples of a PBF system employing principles of this disclosure. It should also be noted that elements of FIGS. 1A-D and the other figures in this disclosure are not necessarily drawn to scale, but may be drawn larger or smaller for the purpose of better illustration of concepts described herein. PBF system 100 can include a depositor 101 that can deposit each layer of metal powder, an energy beam source 103 that can generate an energy beam, a deflector 105 that can apply the energy beam to fuse the powder, and a build plate 107 that can support one or more build pieces, such as a build piece 109. PBF system 100 can also include a build floor 111 positioned within a powder bed receptacle. The walls of the powder bed receptacle 112 generally define the boundaries of the powder bed receptacle, which is sandwiched between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, enabling atmospheric and temperature regulation and mitigating contamination risks. Depositor 101 can include a hopper 115 that contains a powder 117, such as a metal powder, and a leveler 119 that can level the top of each layer of deposited powder.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused slices in multiple layers, e.g., 150 layers, to form the current state of build piece 109, e.g., formed of 150 slices. The multiple layers already deposited have created a powder bed 121, which includes powder that was deposited but not fused.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 that has a thickness substantially equal to the powder layer thickness 123 (see FIG. 1B). Thus, the powder in a PBF system can be supported by a powder support structure, which can include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving 150 previously-deposited layers discussed above with reference to FIG. 1A.

FIG. 1D shows PBF system 100 at a stage in which, following the deposition of powder layer 125 (FIG. 1C), energy beam source 103 generates an energy beam 127 and deflector 105 applies the energy beam to fuse the next slice in build piece 109. In various exemplary embodiments, energy beam source 103 can be an electron beam source, in which case energy beam 127 constitutes an electron beam. Deflector 105 can include deflection plates that can generate an electric field or a magnetic field that selectively deflects the electron beam to cause the electron beam to scan across areas designated to be fused. In various embodiments, energy beam source 103 can be a laser, in which case energy beam 127 is a laser beam. Deflector 105 can include an optical system that uses reflection and/or refraction to manipulate the laser beam to scan selected areas to be fused.

In various embodiments, the deflector 105 can include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas of the powder layer. For example, in various embodiments, the energy beam can be modulated by a digital signal processor (DSP).

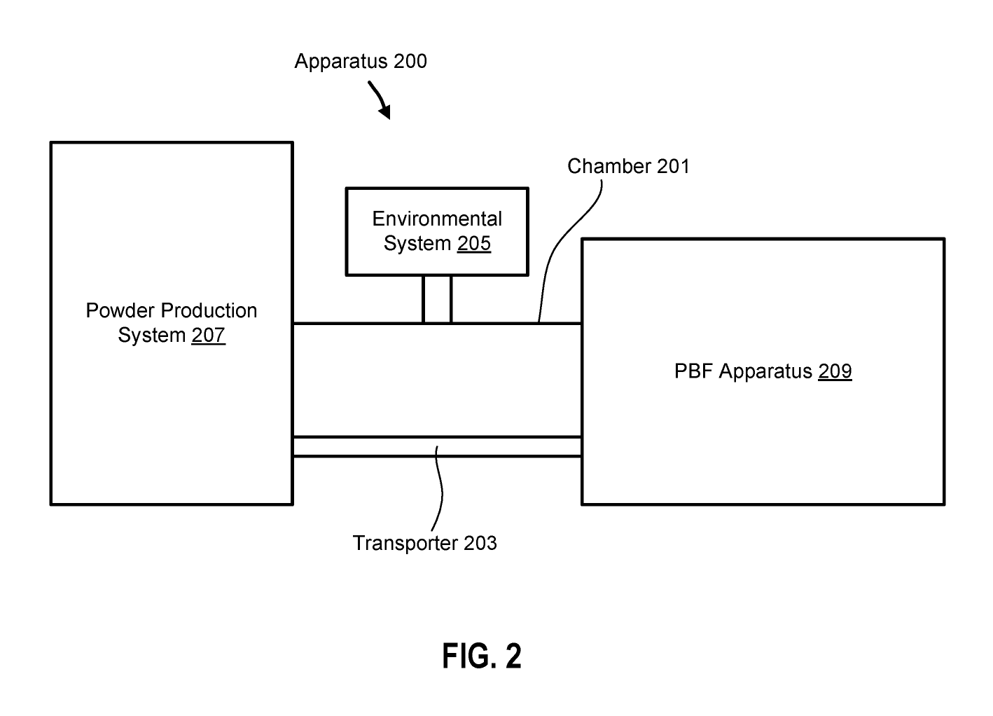

FIG. 2 illustrates an exemplary apparatus 200 for transporting metal powder. Apparatus 200 can include a chamber 201, a transporter 203, and an environmental system 205. In this example, apparatus 200 can transport metal powder from a powder production system 207 to a PBF apparatus 209. In various embodiments, environmental system 205 can create an environment in chamber 201 that decreases exposure of the metal powder to a substance that changes a material property of the metal powder. In the case that the metal powder is iron metal powder, oxygen and atmospheric water (i.e., humidity) are examples of substances that change a material property of the iron metal powder because these substances can cause the iron material of the powder to oxidize, which is a chemical change. Humidity can cause powders to clump, thus changing the flowability of the powder, which is a material property of the powder, i.e., a material property of the bulk powder. In various embodiments, environmental system 205 can decrease exposure of the metal powder to oxygen and/or humidity in the atmosphere.

Oxygen and humidity are examples of substances in air that can change a material property of powders used in PBF systems. In the exemplary cases described above, the changes to the material properties of the powder can also negatively impact the performance of the PBF system. For example, oxidized powder can result in build pieces that have impurities within their metal structure. Clumping powder can be difficult to transport, difficult to deposit, etc., and can result in clogged powder pathways, uneven powder layers, etc.

Fluorine is another example of a substance that can change a material property of powder. However, fluorine is not a common substance found in air. In particular, fluorine is an oxidizing agent for some metals and can cause a chemical change, which is a change in a material property.

In addition, there are some substances that can negatively impact the performance of a PBF system without necessarily changing a material property of the powder. For example, exposing the powder to carbon may not change a material property of the powder itself. However, when a build piece is formed from the powder and carbon mixture, a material property of the build piece can be different than a build piece formed from powder without carbon. For example, the carbon in the metal powder can affect the strength of the metal formed when the powder is fused. In addition, carbon can be reactive, e.g., can react with certain substances, when the build piece cools down. In various embodiments, environmental system 205 can decrease exposure of the metal powder to a substance that causes a material property of the build piece formed from fusing the powder to be different than the material property of a build piece formed from fusing powder not exposed to the substance. In some cases, such a substance does not change a material property of the powder itself

Additionally, some substances that can come in contact with the powder and get trapped and mixed with the powder can negatively impact the performance of the PBF system when the powder is heated to obtain melt pools. For example, some substances can cause the melt pool to spatter, to not form properly, etc. In these cases, a property of the build piece, e.g., a desired shape, can be different than a build piece formed from powder without these substances. In various embodiments, environmental system 205 can decrease exposure of the metal powder to a substance that causes a property of the build piece formed from fusing the powder to be different than the property of a build piece formed from fusing powder not exposed to the substance. In some cases, such a substance does not change a material property of the powder itself.

In sum, various embodiments of an environmental system can create an environment in a chamber that decreases exposure of the metal powder to a substance that changes a material property of the metal powder, decreases exposure of the metal powder to a substance that causes a material property of a build piece formed from fusing the metal powder to be different than the material property of a build piece formed from fusing metal powder not exposed to the substance, and/or decreases exposure of the metal powder to a substance that causes a property of a build piece formed from fusing the powder to be different than the property of a build piece formed from fusing powder not exposed to the substance.

Transporter 203 can transport the metal powder through the environment created by environmental system 205 in the chamber 201. In various embodiments, transporter 203 can be inside chamber 201, e.g., a conveyer belt, etc. In various embodiments, transporter 203 can be outside chamber 201, e.g., a vibrator that vibrates the chamber to move the powder.

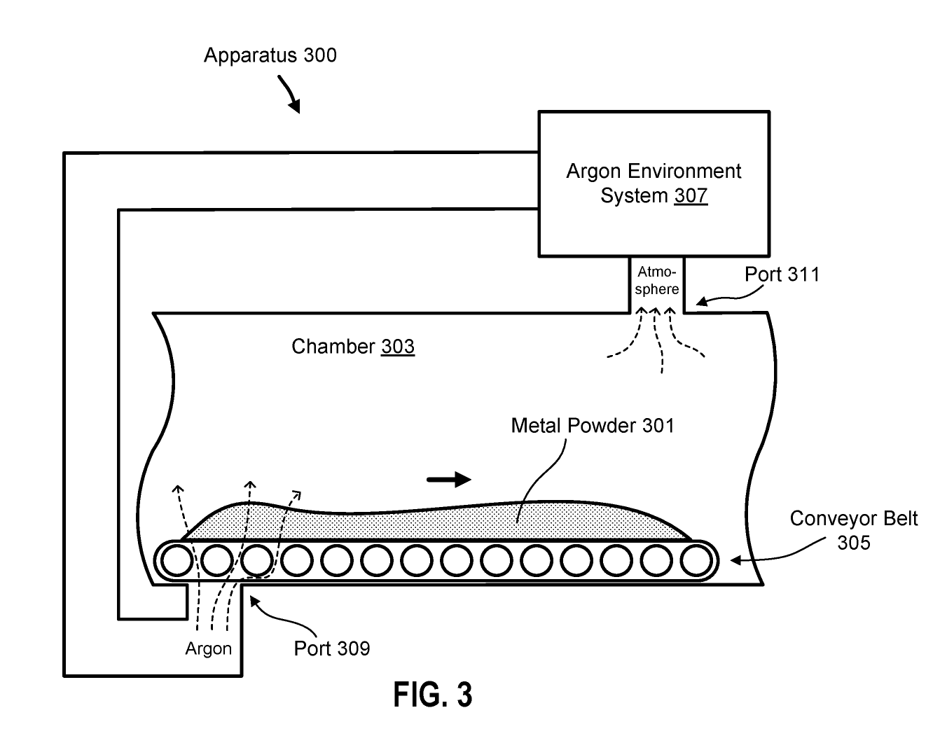

FIG. 3 illustrates an exemplary apparatus 300 for transporting metal powder 301 in an inert gas environment. Apparatus 300 can include a chamber 303, a transporter including a conveyor belt 305, and an environmental system including an argon environment system 307. Argon environment system 307 can inject argon gas through a port 309 in chamber 303 and can remove atmospheric air through a port 311 in the chamber as the air is displaced by the argon gas. In some embodiments, argon environment system 307 can replace all of the air in chamber 303 with argon gas prior to transporting metal powder 301. Because argon gas is heavier than air, in other embodiments, argon environment system 307 can inject argon gas to displace only a portion of the air in the chamber, such that metal powder 301 can be transported through an environment of argon gas only. For example, the argon gas can displace half of the air such that the bottom half of chamber 303 contains only argon gas and the top half of the chamber contains only air. In this case, for example, metal powder 301 can be transported through the lower half of chamber 303 so that the metal powder remains within the space of argon gas.

In the example of FIG. 3, argon environment system 307 is a closed system, in which the system removes air displaced from the chamber. In other embodiments, an inert gas environment system such as argon environment system 307 can be an open system. For example, the air displaced by argon gas can be allowed to vent into the environment surrounding the chamber.

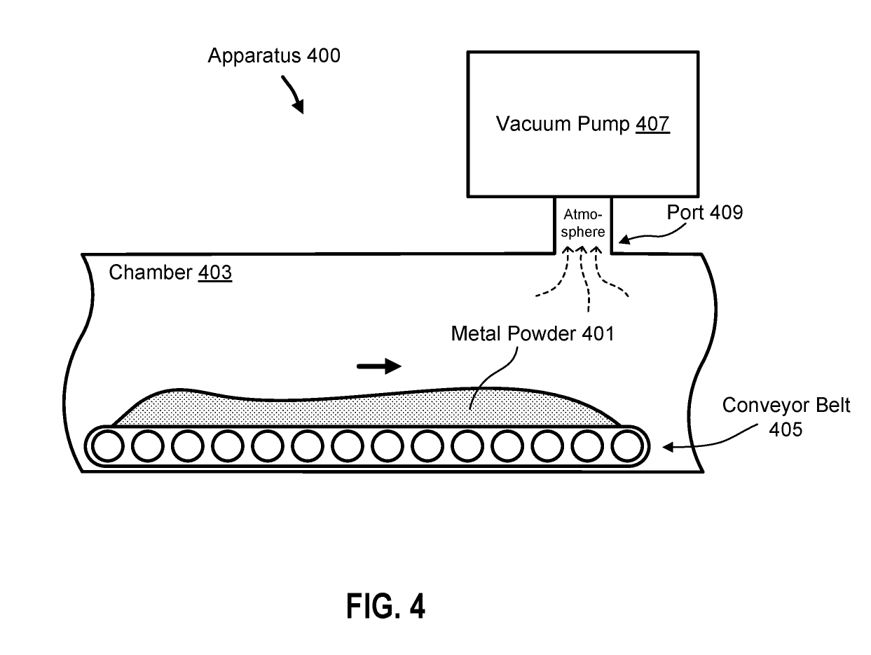

FIG. 4 illustrates an exemplary apparatus 400 for transporting metal powder 401 in a vacuum environment. Apparatus 400 can include a chamber 403, a transporter including a conveyor belt 405, and an environmental system including a vacuum pump 407. Vacuum pump 407 can be connected to chamber 403 through a port 409 and can remove atmospheric air the chamber by pulling a vacuum through the port. Conveyor belt 405 can transport metal powder 401 through the vacuum in chamber 403. Conveyor belt 405 is an example of a transporter that can be inside the chamber.

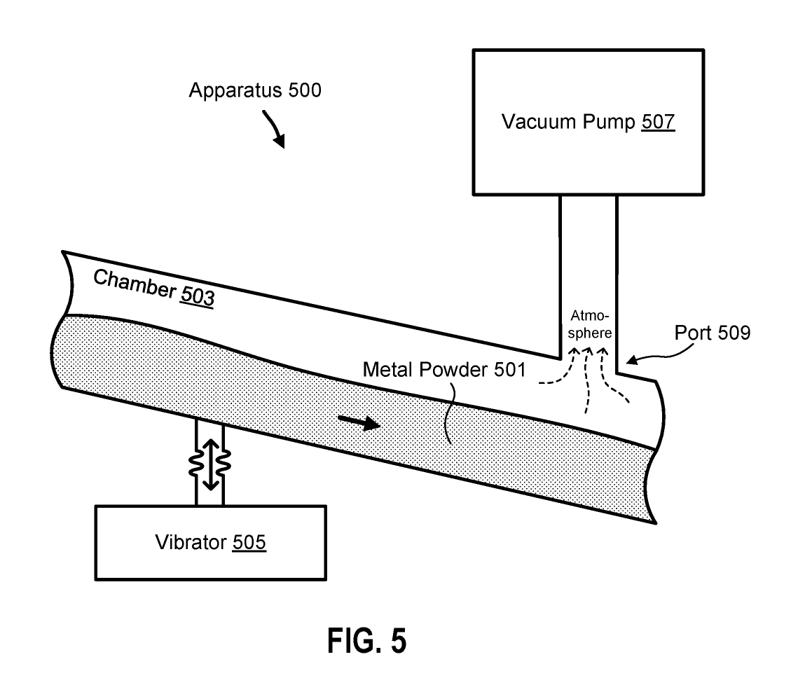

FIG. 5 illustrates an exemplary apparatus 500 for transporting metal powder 501. Apparatus 500 can include a chamber 503, a transporter including a vibrator 505 connected to the chamber, and an environmental system including a vacuum pump 507. Vacuum pump 507 can be connected to chamber 503 through a port 509 and can remove atmospheric air the chamber by pulling a vacuum through the port.

Chamber 503 can be tilted, and vibrator 505 can vibrate the chamber at a frequency that induces metal powder 501 to slide through the tilted chamber. It is noted that the flowability of metal powder 501 is due to liquefaction. Vibrator 505 is an example of a transporter that can be outside the chamber.

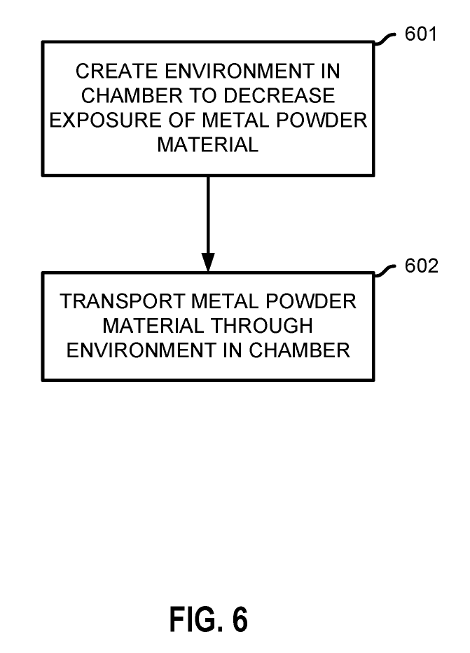

FIG. 6 is a flowchart of an exemplary method of transporting metal powder in a chamber. For example, in various embodiments the method can be used to transport metal powder from a powder production system, such as powder production system 207, to a PBF apparatus, such as PBF apparatus 209. In particular, the method includes creating (601) an environment in the chamber that decreases exposure of the metal powder to a substance that changes a material property of the metal powder. In various embodiments, for example in the case that the metal powder is iron metal powder, oxygen and atmospheric water (i.e., humidity) can be removed from the environment in the chamber to prevent or decrease oxidation. In various embodiments, humidity can be removed from the chamber environment to prevent or decrease the amount of clumping of the powder mass caused by humidity. In various embodiments, environmental system 205 can decrease exposure of the metal powder to oxygen and/or humidity in the atmosphere. After the environment has been created, the method includes transporting (602) the metal powder through the environment in the chamber.

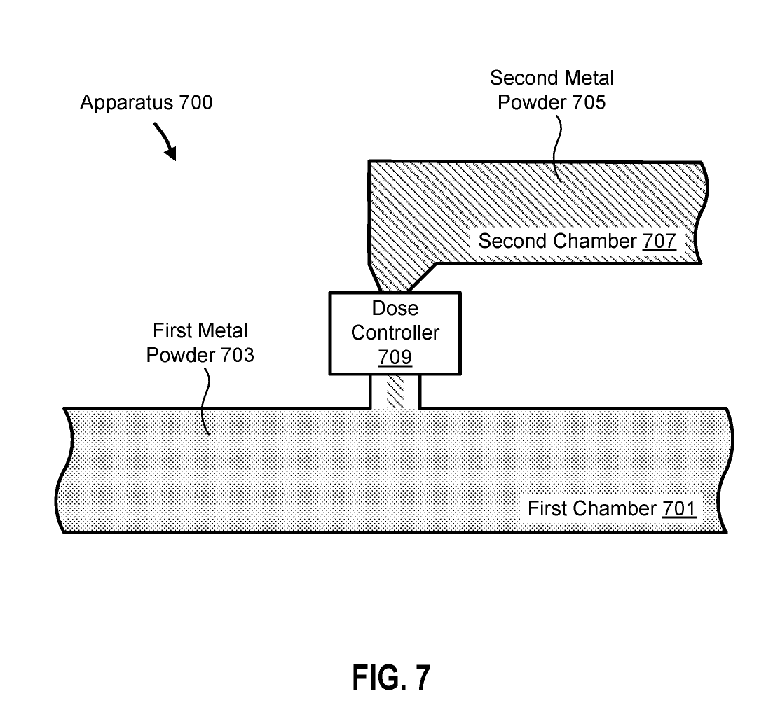

FIG. 7 illustrates an exemplary apparatus 700 that can mix two metal powders for a PBF system. A first chamber 701 can accept a first metal powder 703 and a second metal powder 705. A second chamber 707 can be connected to first chamber 701 through a dose controller 709. Dose controller 709 can control a dose of second metal powder 705 from second chamber 707 into first chamber 701 based on a characteristic the first metal powder, or the second metal powder, or both the first and second metal powders. In this way, for example, apparatus 700 can create a mixture of first metal powder 703 and second metal powder 705 based on a particular characteristic. For the purpose of illustration, apparatus 700 is shown in FIG. 7 at a time when dose controller 709 has begun dosing second metal powder 705, but the second metal powder has not yet mixed with first metal powder 703. It should be understood that a mixture of first and second powders can include merely the presence of the first and second powders in the same chamber, without necessarily including co-mingling of the two powders. For example, one powder resting on top of the other powder can be a mixture. In various embodiments, the two powders can be actively co-mingled by, for example, agitation of the chamber, movement of the mixture through the chamber, etc.

The mixture can be used in a PBF system, for example, and the mixing can be controlled to achieve a desired quality of the mixed powder for use in the PBF system. In various embodiments, either the first or the second powder can be new powder, and the other powder can be powder that has been recovered after a print operation because the powder was not fused during the print operation.

In various embodiments, the characteristic can include flowability. For example, a PBF system can require a minimum amount of flowability of the mixed powder, and the powders can be mixed based on a flowability characteristic in order to achieve the desired flowability of the mixed powder.

In various embodiments, the characteristic can include an amount of contamination. For example, a PBF system can require the mixed powder to have less than a maximum amount of contamination, and the powders can be mixed based on a characteristic that includes an amount of contamination in order to achieve less than the maximum amount of contamination of the mixed powder.

In various embodiments, the characteristic can include a print history. For example, the first powder can be new powder, and the second powder can be powder that has been recovered from a print operation of the PBF system. During a print operation, various factors can cause the not-fused powder to degrade. In this case, the recovered powder may have a reduced effectiveness due to being degraded by being used in one or more print operations. A PBF system can adjust the ratio of the first and second powders in the mixture based on how many times the second powder has been used in a print operation. In this way, for example, powder that has already been used in one or more print operations can be reused by mixing the powder with new powder in an appropriate ratio.

In various embodiments, the characteristic can include a print performance. For example, the first powder can be new powder, and the second powder can be powder that has been recovered from a print operation of the PBF system. During a print operation, the performance of the powder can be determined. In this case, the recovered powder may have performed well (e.g., allowed consistent melt pools to be formed) and, therefore, may be mixed at a higher ratio than a powder that did not perform well in the printing process.

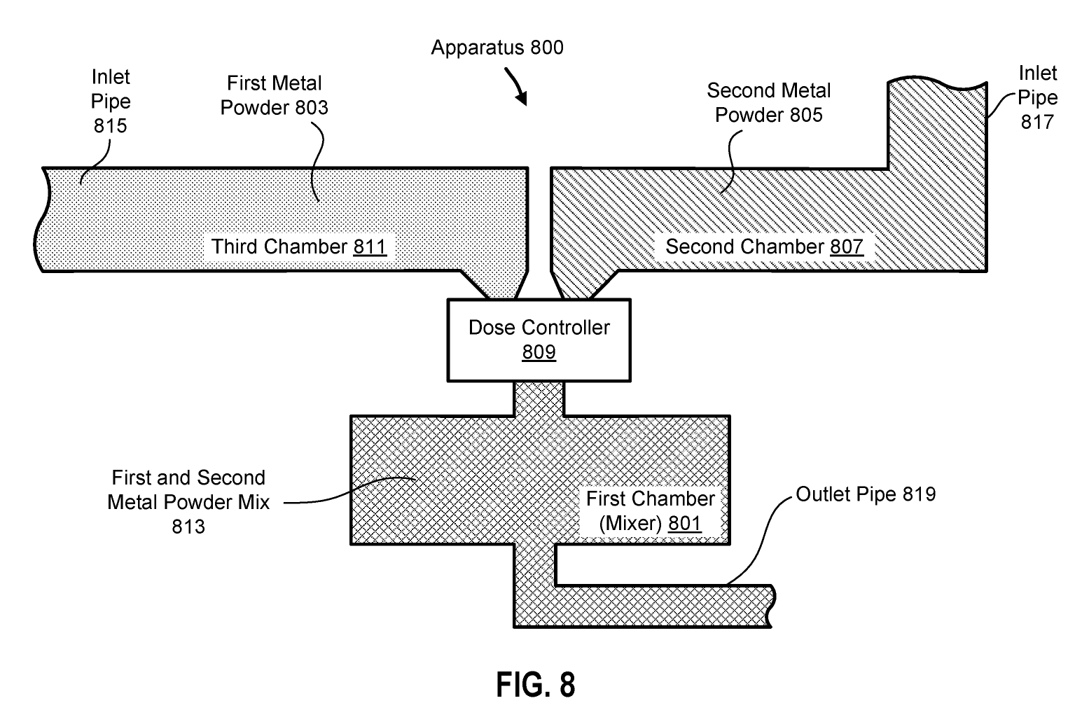

FIG. 8 illustrates an exemplary apparatus 800 that can mix two metal powders for a PBF system. A first chamber 801 can accept a first metal powder 803 and a second metal powder 805. A second chamber 807 can be connected to first chamber 801 through a dose controller 809. A third chamber 811 can also be connected to first chamber 801 through dose controller 809. Dose controller 809 can control a dose of second metal powder 805 from second chamber 807 into first chamber 801 and can control a dose of first metal powder 803 from third chamber 811 into the first chamber based on a characteristic the first metal powder, or the second metal powder, or both the first and second metal powders. FIG. 8 illustrates a first and second metal powder mix 813 in first chamber 801.

Third chamber 811 can receive first metal powder 803 through an inlet pipe 815. In various embodiments, for example, inlet pipe 815 can be connected to a powder production system, such as powder production system 207, and first metal powder 803 can be new metal powder that is received from the powder production system through the inlet pipe.

Second chamber 807 can receive second metal powder 805 through an inlet pipe 817. In various embodiments, for example, inlet pipe 817 can be connected to a powder recovery system (examples of which are discussed below), and second metal powder 805 can be recovered metal powder that is received from the powder recovery system through the inlet pipe.

First and second metal powder mix 813 can exit first chamber 801 through an outlet pipe 819. In various embodiments, for example, outlet pipe 819 can be connected to a PBF apparatus, such as PBF apparatus 209, and first and second metal powder mix 813 can be delivered to the PBF apparatus through the outlet pipe.

Like exemplary apparatus 700, apparatus 800 can create a mixture of a first metal powder and a second metal powder based on a particular characteristic. The mixture can be used in a PBF system, for example, and the controlled mixing can account for a desired quality of the mixed powder for use in the PBF system.

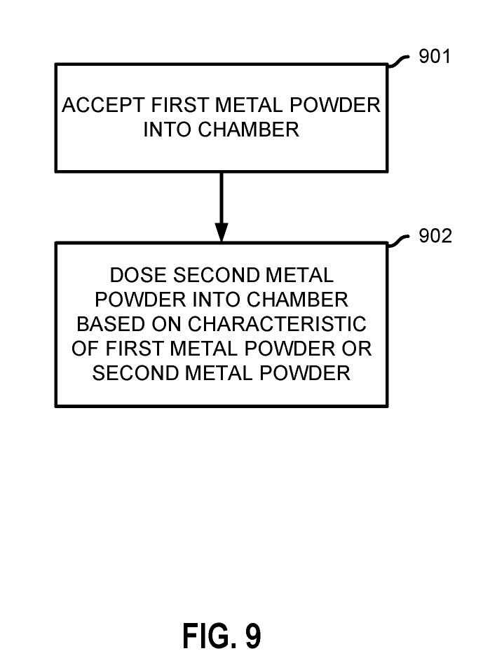

FIG. 9 is a flowchart of an exemplary method of mixing metal powder for a PBF system. For example, in various embodiments the method can be used to mix metal powder from a powder production system, such as powder production system 207, with powder recovered from a PBF apparatus, such as PBF apparatus 209. In particular, the method includes accepting (901) a first metal powder into a chamber and dosing (902) a second metal powder into the chamber based on a characteristic of at least the first metal powder or the second metal powder. In various embodiments, the second metal powder can be dosed from a second chamber connected to the first chamber. In various embodiments, the mixed powder can be used in a PBF system, for example, and the mixing can be controlled to achieve a desired quality of the mixed powder for use in the PBF system. In various embodiments, either the first or the second powder can be new powder, and the other powder can be powder that has been recovered after a print operation because the powder was not fused during the print operation. The characteristic can include, for example, flowability, an amount of contamination, a print history, a print performance, etc.

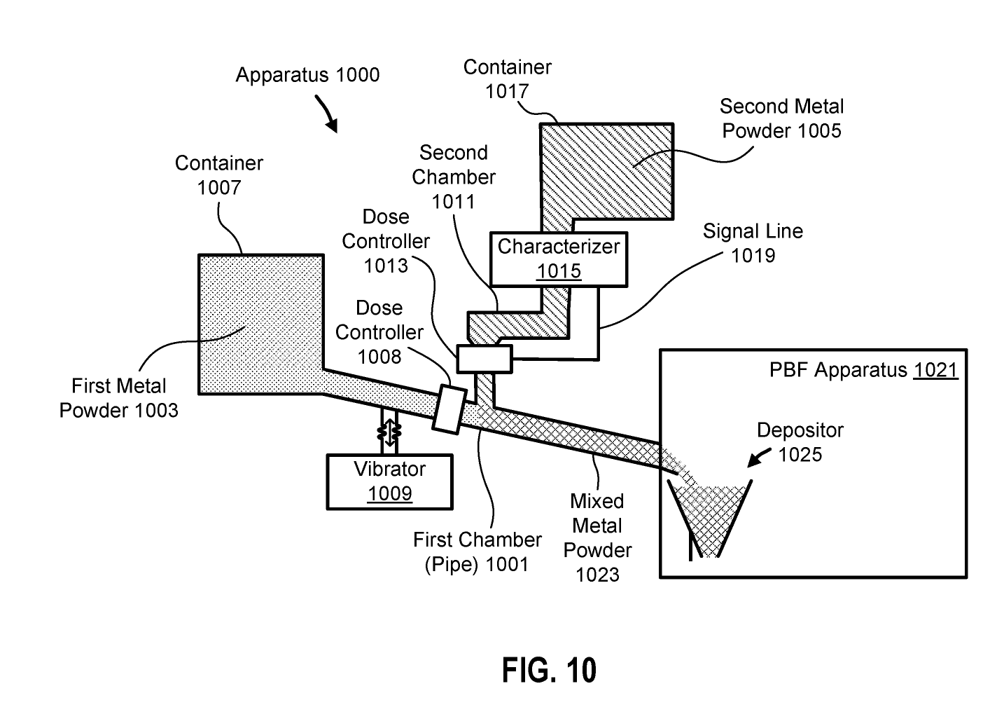

FIG. 10 illustrates exemplary apparatus 1000 that can mix two metal powders for a PBF system. A first chamber 1001 can accept a first metal powder 1003 and a second metal powder 1005. In this example, first chamber 1001 is a pipe. First chamber 1001 is connected to a container 1007 through a dose controller 1008. First metal powder 1003 in container 1007 can be dosed into first chamber 1001 by dose controller 1008 and can be transported through the first chamber by a vibrator 1009. A second chamber 1011 can be connected to first chamber 1001 through a dose controller 1013. Apparatus 1000 can include a characterizer 1015 connected between second chamber 1011 and a container 1017 that contains second metal powder 1005. Characterizer 1015 can determine a characteristic of second metal powder 1005 and can send characteristic information to dose controller 1013 through a signal line 1019. Dose controller 1013 can control a dose of second metal powder 1005 from second chamber 1011 into first chamber 1001 based on the characteristic information of second metal powder 1005. In this way, for example, apparatus 1000 can create a mixture of first metal powder 1003 and second metal powder 1005 based on a particular characteristic of the second metal powder. Dose controllers 1008 and 1013 can control the doses of first metal powder 1003 and second metal powder 1005, respectively, based on a relative control (e.g., a ratio of the first and second metal powders) or an absolute control (e.g., a total amount of the first and/or second powders).

In this example, first chamber 1001 is connected to a PBF apparatus 1021, such that mixed metal powder 1023 (i.e., the controlled mixture of first metal powder 1003 and second metal powder 1005) can be received by a depositor 1025 of the PBF apparatus. In this way, for example, PBF apparatus 1021 can be supplied with a controlled mixture of first metal powder 1003 and second metal powder 1005.

In various embodiments, characterizer 1015 can include, for example, a flowability determiner that determines flowability of the second metal powder, a contamination determiner that determines an amount of contamination of the second metal powder, a print history determiner that determines a print history of the second metal powder, a print performance determiner that determines a print performance of the second metal powder, etc.

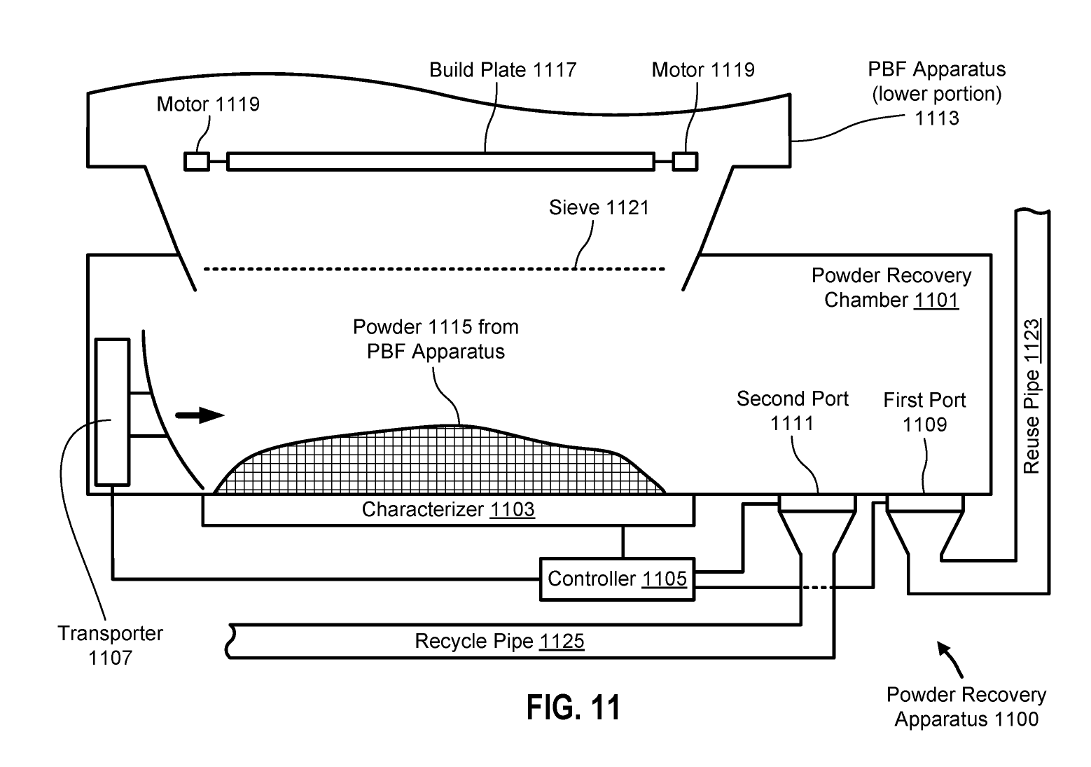

FIG. 11 illustrates an exemplary powder recovery system 1100 for a PBF system. Powder recovery apparatus 1100 can include a powder recovery chamber 1101, a characterizer 1103, a controller 1105, a transporter 1107, a first port 1109, and a second port 1111. Powder recovery system 1100 can be positioned below a PBF apparatus 1113. Only the lower portion of PBF apparatus 1113 is shown in FIG. 11. Powder recovery system 1100 can receive powder 1115 from PBF apparatus after the powder has been through a print operation. For example, a build plate 1117 of PBF apparatus can be connected to motors 1119. After the print operation, motors 1119 can rotate build plate 1117 to dump the powder bed onto a sieve 1121. Sieve 1121 can capture the build pieces in the powder bed and allow the non-fused powder, i.e., powder 1115, to fall through to powder recovery chamber 1101 onto characterizer 1103.

Characterizer 1103 can determine a characteristic of powder 1115 and can send characteristic information to controller 1105. For example, characterizer 1103 can determine an amount of contamination of powder 1115. Based on the characteristic information, controller 1105 can determine whether to reuse powder 1115. For example, controller 1105 can determine whether powder 1115 is too contaminated to be reused. If controller 1105 determines powder 1115 should be reused, the controller can control first port 1109 to open (while second port 1111 remains closed) and can control transporter 1107 to move powder 1115 over the first port, so that the powder is dumped into a reuse pipe 1123. For example, if the powder is not too contaminated, the powder can be reused by the PBF apparatus. On the other hand, if controller 1105 determines powder 1115 should not be reused, the controller can control second port 1111 to open (while first port 1109 remains closed) and can control transporter 1107 to move powder 1115 over the second port, so that the powder is dumped into a recycle pipe 1125. For example, if the powder is too contaminated to be reused, the powder can be recycled to create new powder for the PBF apparatus. In this way, for example, powder that has been through a print operation of a PBF apparatus can be reused, recycled, etc., based on a determination of whether the powder is suitable for reusing, recycling, etc., which can reduce waste and reduce the cost of operating PBF systems.

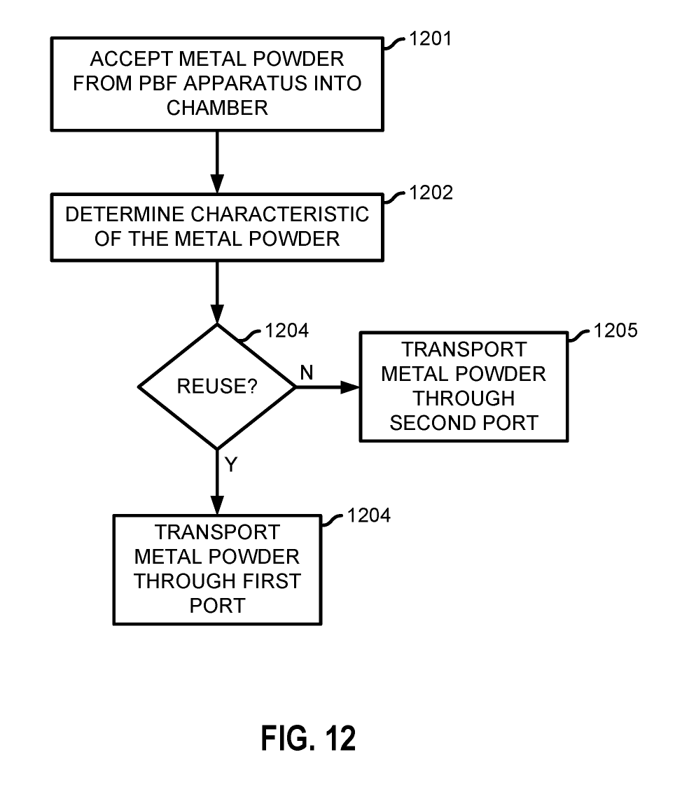

FIG. 12 is a flowchart of an exemplary method of recovering metal powder in a PBF system. Metal powder that has been through a print operation can be accepted (1201) into a chamber that includes a first port and a second port. A characteristic of the powder can be determined (1202). For example, a level of contamination, a print history (e.g., a number of times the powder has been reused in the print operation), etc., can be determined. The method can determine (1203) whether to reuse the metal powder based on the characteristic. If it is determined that the powder should be reused, the powder can be transported (1204) through the first port. In various embodiments, the first port can be connected to a reuse path that transports the powder to be reused in the PBF system. For example, the reuse path can include a pipe that transports the powder to be mixed with new powder, and the mixed powder can be transported to the depositor for reuse. In various embodiments, the powder can be decontaminated by a decontamination system before being mixed or being used directly in the PBF system. If it is determined that the powder should not be reused, the powder can be transported (1205) through the second port. In various embodiments, the second port can be connected to a recycle path that transports the powder to be recycled. For example, the recycle path can include a pipe that transports the powder to a metal atomizer that melts the powder and creates new powder from the liquid metal.

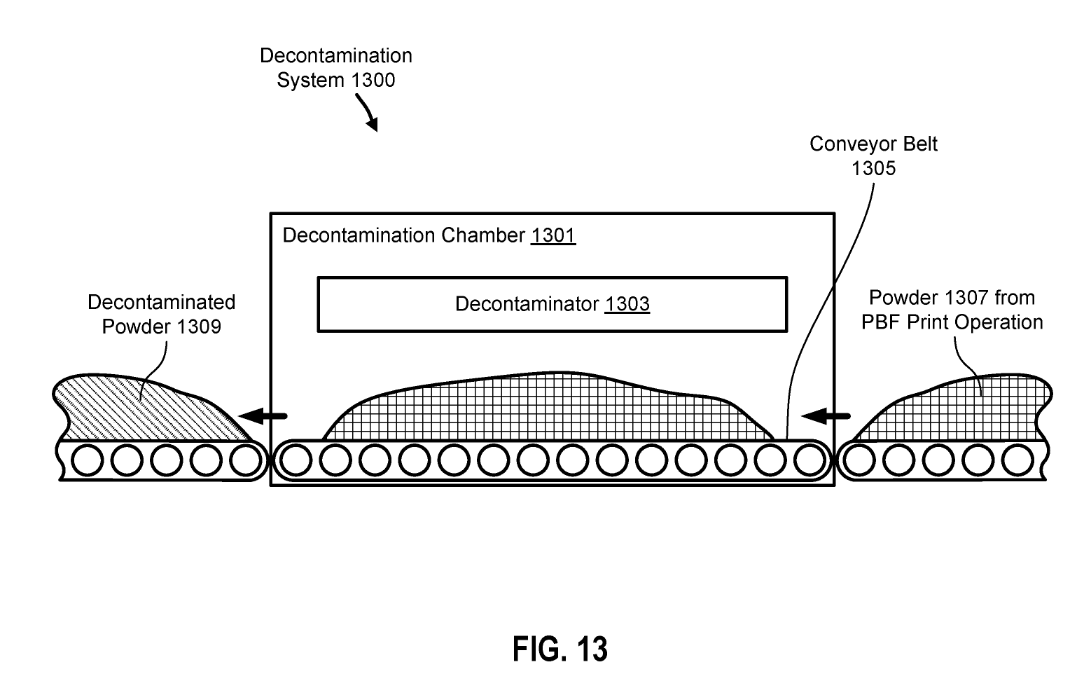

FIG. 13 illustrates an exemplary powder decontamination system 1300 for a PBF system. Powder decontamination system 1300 can include a decontamination chamber 1301, a decontamination system 1303, and a conveyor belt 1305. Powder 1307 from a PBF print operation can be transported into chamber 1301 by conveyor belt 1305. Decontamination system 1303 can decontaminate powder 1307. For example, decontamination system 1303 can include a decontamination furnace that can heat powder to remove contaminants without melting or sintering the powder. In various embodiments, the decontamination furnace can be a vacuum furnace that can heat the powder in a vacuum environment. Conveyor belt 1305 can transport decontaminated powder 1309 out of chamber 1301. In various embodiments, decontaminated powder 1309 can be reused in the PBF system.

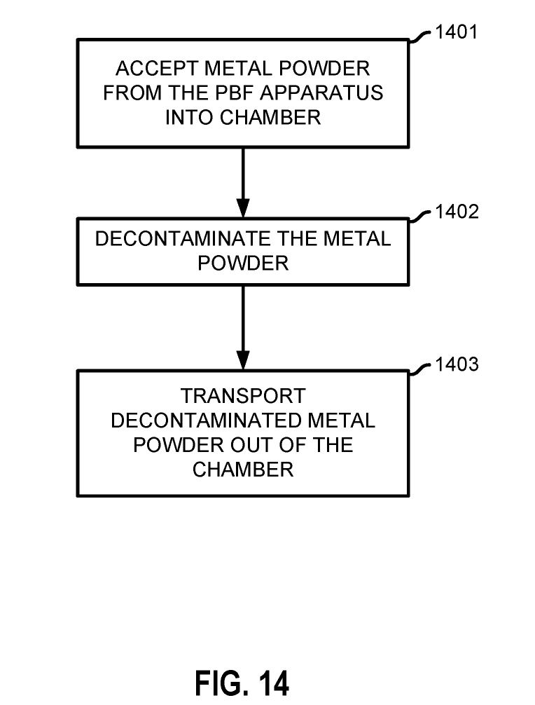

FIG. 14 is a flowchart of an exemplary method of decontaminating powder in a PBF system. Metal powder that has been through a print operation can be accepted (1401) into a chamber. The powder can be decontaminated (1402). For example, the powder can be heated to remove contaminants without melting or sintering the powder. In various embodiments, the powder can be in a vacuum environment while being heated. The powder can be transported (1403) out of the chamber. In various embodiments, the decontaminated powder can be reused in the PBF system.

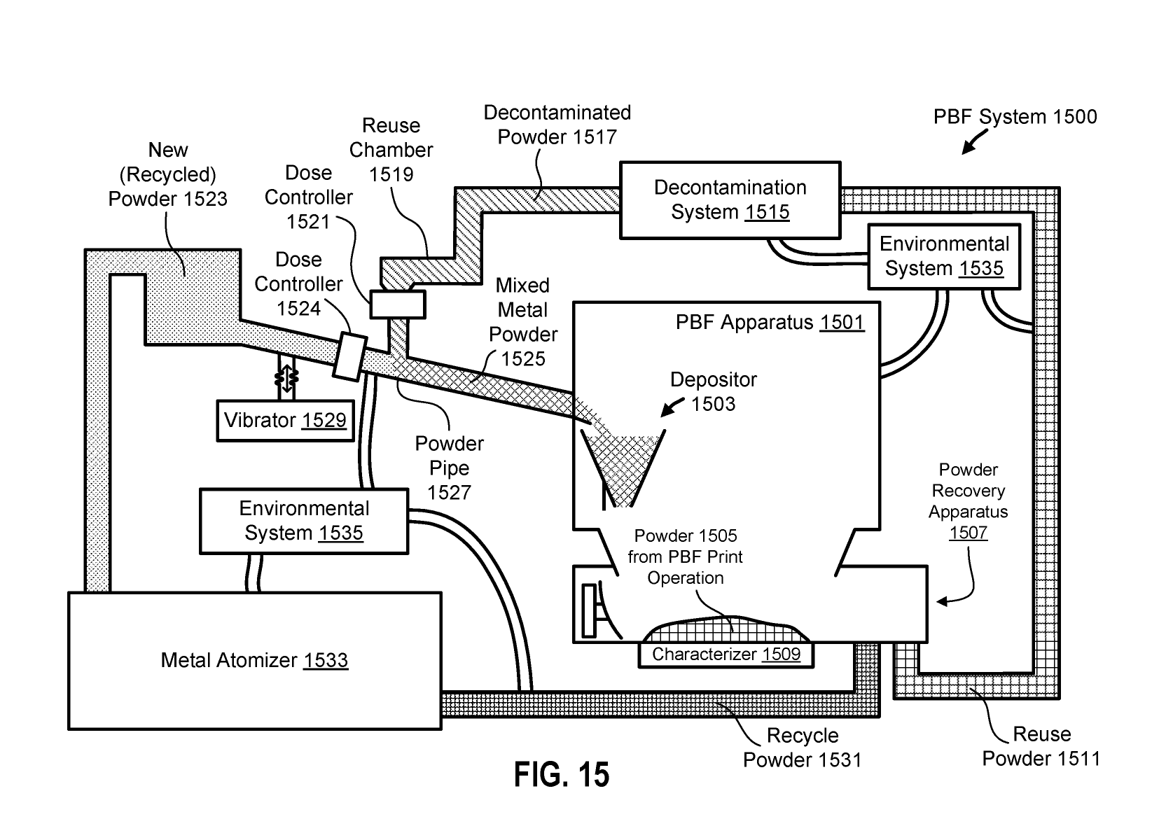

FIG. 15 illustrates an exemplary PBF system 1500 that includes powder reusing and recycling with environmental control. PBF system 1500 can include a PBF apparatus 1501 that can perform print operations to print 3-D build pieces. PBF apparatus can include a depositor 1503 that can deposit powder for the PBF print operation. For the sake of clarity, other components of PBF apparatus are not shown. After a print operation of PBF apparatus 1501, powder 1505 can be recovered by a powder recovery apparatus 1507, such as powder recovery apparatus 1100 of FIG. 11. A powder characterizer 1509 of powder recovery apparatus 1507 can determine a characteristic of powder 1505, such as a level of contamination. Powder recovery apparatus 1507 can determine whether to reuse, recycle, etc., powder 1505.

If powder recovery apparatus 1507 determines to reuse powder 1505, the powder can be deposited in a pipe of reuse powder 1511. Reuse powder 1511 can be transported to a decontamination system 1515, such as decontamination system 1300 of FIG. 13, which can include, for example, a decontamination furnace. Decontamination system 1515 can decontaminate reuse powder 1511 to create decontaminated powder 1517. PBF system 1500 can transport decontaminated powder 1517 to a reuse chamber 1519, from which the decontaminated powder can be dosed by a dose controller 1521 for mixing with a new powder 1523, which can be dosed by a dose controller 1524, to create a mixed powder 1525 in a powder pipe 1527, for example, in a similar way as described for apparatus 1000 of FIG. 10. A vibrator 1529 can vibrate powder pipe 1527 to transport mixed powder 1525 through the powder pipe to be deposited into depositor 1503 to be used for print operations of PBF apparatus 1501.

On the other hand, if powder recovery apparatus 1507 determines not to reuse powder 1505, the powder can be deposited in a pipe of recycle powder 1531. PBF system 1500 can transport recycle powder 1531 to a metal atomizer 1533, which can heat and melt the recycle powder to create new (recycled) powder 1523. PBF system 1500 can transport the new (recycled) powder to powder pipe 1527 for mixing with decontaminated powder 1517.

PBF system 1500 can include an environmental system 1535 that can create an environment that decreases exposure of the powder to a substance that changes a material property of the metal powder. For example, environmental system 1535 can operate in a similar way as environmental system 205 of FIG. 2. Environmental system 1535 can be connected at various points to various components of PBF system 1500, such that the transporting, handling, and using of powder in the PBF system can be performed in an environment that decreases exposure of the powder to a substance that changes a material property of the powder and/or changes a property of a build piece formed from the exposed powder.

In various embodiments, the powder transport, handling, and use can be accomplished in a closed system, e.g., an air-tight system. In various embodiments, air-locks can be positioned between different sections of the closed system so that a section can be sealed off from other sections, e.g., so that the section can be accessed from the outside while maintaining the environment in the remaining sections. In various embodiments, build pieces can be inspected, and rejected build pieces can be recycled along with the recycled powder. Thus, various exemplary embodiments described above and other embodiments can allow the efficient reuse, recycling, etc., of powder and can offer cost savings for PBF systems and reduce negative environmental impact of such systems.

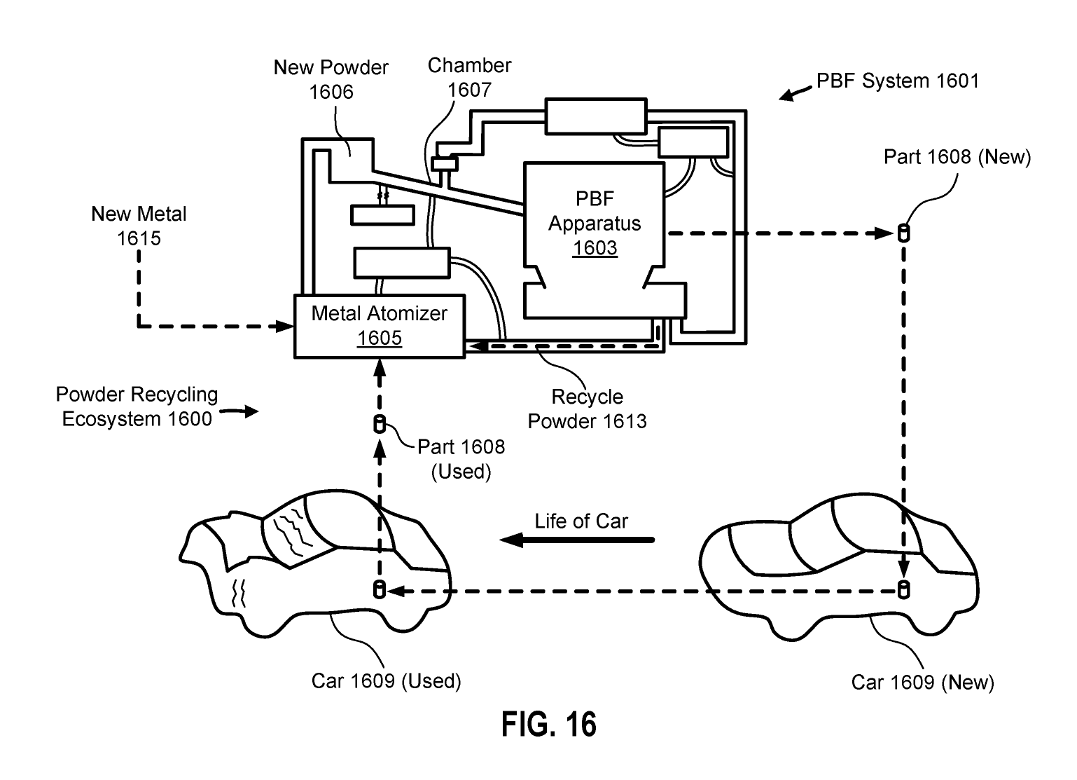

FIG. 16 illustrates an exemplary powder recycling ecosystem 1600 that can provide the ability to generate new powder alloys through recycled materials. A PBF system 1601, such as PBF system 1500, can include a PBF apparatus 1603 and a metal atomizer 1605. PBF system 1601 can also include components for reusing and recycling powder, creating and maintaining a controlled environment, decontaminating powder, dosing reuse powder and new powder, etc., as described above in various exemplary embodiments. PBF apparatus 1603 can receive powder to print build pieces. The powder can include new powder 1606, which can be created by metal atomizer 1605. New powder 1606 can be transported to PBF apparatus through a chamber 1607. The environment in chamber 1607 can be created and maintained to decrease exposure of the new powder 1606 to a substance that changes a material property of the new powder. For example, various method described above for creating and maintaining such an environment can be used. PBF apparatus 1603 can print build pieces, such as a part 1608. In this example, part 1608 is an automobile part for a car 1609.

When car 1609 is built as a new car, part 1608 is also new. In powder recycling ecosystem 1600, part 1608 can be returned to PBF system 1601 when the part has served its purpose. For example, part 1608 can be returned if the part fails, if the part is replaced during routine maintenance, at the end of life of car 1609 (as shown in the example of FIG. 16), etc. When part 1608 is returned to PBF system 1601, the part can be melted in metal atomizer 1605, and the molten metal can be used to create new powder 1606. Metal atomizer 1605 can also melt recycle powder 1613 from PBF apparatus 1603 and mix the molten metal from the recycle powder with the molten metal from part 1608, for example. Metal atomizer 1605 can also receive new metal 1615 and can melt the new metal and add this molten metal to the mix of molten metals as well. In other words, metal atomizer 1605 can create new powder 1606 from various combinations of two or more of these three sources of metal, i.e., metal from part 1608, metal from recycle powder 1613, and new metal 1615, or can create the new powder from one of the three sources, depending on the needs of PBF system 1601 and the availability of each source of metal. In this way, for example, a recycling ecosystem can be created to reduce material cost for automobile manufacturers and to lessen the environmental impact of automobile manufacturing.

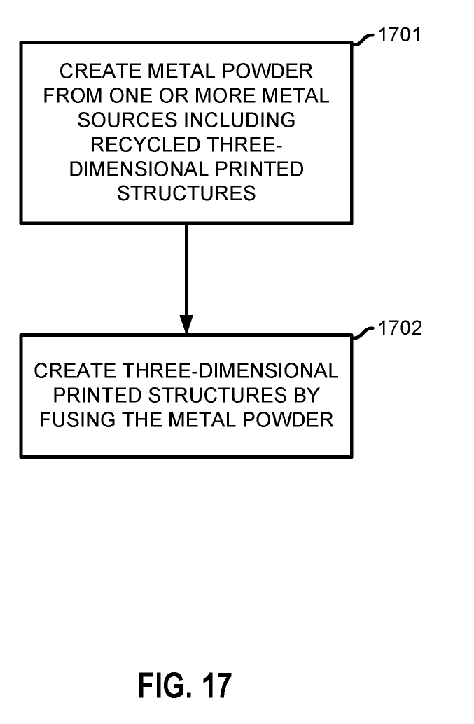

FIG. 17 is a flowchart of an exemplary method of powder recycling in a powder recycling ecosystem. A PBF system can create (1701) metal powder from one or more metal sources including recycled three-dimensional printed structures. For example, powder recycling ecosystem 1600 illustrates an exemplary system of recycling using PBF system 1601. The PBF system can create (1702) three-dimensional printed structures by fusing the metal powder.

The previous description is provided to enable any person skilled in the art to practice the various aspects described herein. Various modifications to these exemplary embodiments presented throughout this disclosure will be readily apparent to those skilled in the art. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An apparatus for transporting metal powder, comprising:
a chamber;
a transporter that transports the metal powder through the chamber; and
an environmental system that creates an environment in the chamber that decreases exposure of the metal powder to a substance that changes a material property of the metal powder.

2. The apparatus of claim 1, wherein the environmental system includes an inert gas system that injects an inert gas into the chamber.

3. The apparatus of claim 2, wherein the inert gas includes argon gas.

4. The apparatus of claim 1, wherein the environmental system includes a vacuum pump that creates a vacuum environment in the chamber.

5. The apparatus of claim 1, wherein the substance includes oxygen.

6. The apparatus of claim 1, wherein the substance includes water.

7. The apparatus of claim 1, further comprising a metal atomizer connected to the chamber, wherein the metal atomizer creates the metal powder from one or more metal sources including recycled three-dimensional printed structures.

8. An apparatus for a powder-bed fusion system, comprising:
a chamber;
a transporter that transports the metal powder through the chamber; and
a vacuum pump connected to the chamber.

9. An apparatus for a powder-bed fusion system, comprising:
a chamber;
a transporter that transports the metal powder through the chamber; and
an inert gas system that injects an inert gas into the chamber.

10. The apparatus of claim 9, wherein the inert gas system is a closed system that is further configured to remove air displaced from the chamber, wherein the air is displaced by the inert gas.

11. The apparatus of claim 9, wherein the inert gas includes argon gas.

12. An apparatus for transporting metal powder, comprising:
a chamber;
a transporter that transports the metal powder through the chamber; and
an environmental system that creates an environment in a chamber that decreases exposure of the metal powder to a substance that causes a property of a build piece formed from fusing the metal powder to be different than the property of a build piece formed from fusing metal powder not exposed to the substance.

13. The apparatus of claim 12, wherein the property is a material property.

14. An apparatus for a powder-bed fusion system, comprising:
a first chamber that accepts a first metal powder and a second metal powder;
a second chamber connected to the first chamber; and
a dose controller that controls a dose of the second metal powder from the second chamber into the first chamber based on a characteristic of at least the first metal powder or the second metal powder.

15. The apparatus of claim 14, wherein the second metal powder is metal powder from the powder-bed fusion system.

16. The apparatus of claim 15, further comprising a powder recovery system that recovers the second metal powder from the powder-bed fusion system after a three-dimensional (3D) printing process.

17. The apparatus of claim 15, further comprising a powder characterizer that determines the characteristic.

18. The apparatus of claim 17, wherein the powder characterizer comprises a flowability determiner that determines a flowability, wherein the characteristic includes the flowability.

19. The apparatus of claim 17, wherein the powder characterizer comprises a contamination determiner that determines an amount of contamination, wherein the characteristic includes the amount of contamination.

20. The apparatus of claim 17, wherein the powder characterizer comprises a print history determiner that determines a print history, wherein the characteristic includes the print history.

21. The apparatus of claim 17, wherein the powder characterizer comprises a print performance determiner that determines a print performance, wherein the characteristic includes the print performance.

22. The apparatus of claim 14, further comprising a third chamber connected to the first chamber and configured to dose the first metal powder into the first chamber.

23. The apparatus of claim 14, wherein the first chamber comprises a pipe, and the first metal powder moves through the pipe.

24. The apparatus of claim 14, further comprising a metal atomizer connected to the first chamber, wherein the metal atomizer creates the first metal powder from one or more metal sources including recycled three-dimensional printed structures.

25. An apparatus for a powder-bed fusion system, comprising:
a chamber that accepts a metal powder from the powder-bed fusion system, the chamber including a first port and a second port;
a powder characterizer that determines a characteristic of the metal powder;
a controller that determines whether to reuse the metal powder based on the characteristic; and
a powder transporter that transports the metal powder through the first port if the controller determines the metal powder should be reused and that transports the metal powder through the second port if the controller determines the metal powder should not be reused.

26. The apparatus of claim 25, further comprising a metal atomizer coupled to the second port, wherein the metal atomizer heats the metal powder transported though the second port into a liquid metal and produces new metal powder from the liquid metal.

27. The apparatus of claim 26, wherein the metal atomizer further heats recycled three-dimensional printed structures into the liquid metal.

28. The apparatus of claim 25, further comprising a decontamination component that decontaminates the metal powder, the decontamination component being coupled to the first port.

29. The apparatus of claim 25, further comprising:
a second chamber that accepts the metal powder and new metal powder;
a dose controller that determines a ratio of metal powder to new metal powder; and
a mixer that mixes the metal powder with new metal powder in the second chamber based on the ratio.

30. An apparatus for a powder-bed fusion system, comprising:
a chamber that accepts a metal powder from the powder-bed fusion system;
a decontamination component that decontaminates the metal powder; and
a powder transporter that transports the metal powder into the chamber and that transports the decontaminated metal powder out of the chamber.

31. The apparatus of claim 30, wherein the decontamination component comprises a vacuum furnace that heats the metal powder.

32. The apparatus of claim 30, further comprising:
a second chamber that accepts the decontaminated metal powder and new metal powder;
a dose controller that determines a ratio of decontaminated metal powder to new metal powder and that mixes the decontaminated metal powder with new metal powder in the second chamber based on the ratio.

33. The apparatus of claim 32, further comprising a metal atomizer connected to the second chamber, wherein the metal atomizer creates the new metal powder from one or more metal sources including recycled three-dimensional printed structures.

34. An apparatus for a powder-bed fusion (PBF) system, comprising:
a PBF apparatus that creates three-dimensional printed structures by fusing metal powder; and
a metal atomizer connected to the PBF apparatus, wherein the metal atomizer creates the metal powder from one or more metal sources including recycled three-dimensional printed structures.

35. The apparatus of claim 34, wherein the one or more metal sources further includes recycled powder from the PBF apparatus.

36. A method for transporting metal powder in a chamber, comprising:
creating an environment in the chamber that decreases exposure of the metal powder to a substance that changes a material property of the metal powder; and
transporting the metal powder through the chamber.

37. The method of claim 36, wherein creating the environment comprises injecting an inert gas into the chamber.

38. The method of claim 37, wherein the inert gas includes argon gas.

39. The method of claim 36, wherein creating the environment comprises creating a vacuum in the chamber.

40. The method of claim 36, wherein the substance includes oxygen.

41. The method of claim 36, wherein the substance includes water.

42. The method of claim 36, further comprising creating the metal powder from one or more metal sources including recycled three-dimensional printed structures.

43. A method for transporting metal powder in a chamber, comprising:
creating a vacuum in the chamber; and
transporting the metal powder through the vacuum in the chamber.

44. A method for transporting metal powder in a chamber, comprising:
injecting an inert gas into the chamber; and
transporting the metal powder through the inert gas in the chamber.

45. The method of claim 44, wherein the inert gas system is a closed system that is further configured to remove air displaced from the chamber, wherein the air is displaced by the inert gas.

46. The method of claim 44, wherein the inert gas includes argon gas.

47. A method for transporting metal powder, comprising:
creating an environment in a chamber that decreases exposure of the metal powder to a substance that causes a property of a build piece formed from fusing the metal powder to be different than the property of a build piece formed from fusing metal powder not exposed to the substance; and
transporting the metal powder through the chamber.

48. The method of claim 47, wherein the property is a material property.

49. A method for a powder-bed fusion system, comprising:
accepting a first metal powder into a first chamber; and
dosing a second metal powder into the first chamber from a second chamber connected to the first chamber based on a characteristic of at least the first metal powder or the second metal powder.

50. The method of claim 49, wherein the second metal powder is metal powder from the powder-bed fusion system.

51. The method of claim 50, further comprising recovering the second metal powder from the powder-bed fusion system after a three-dimensional (3D) printing process.

52. The method of claim 50, further comprising determining the characteristic.

53. The method of claim 52, wherein determining the characteristic comprises a determining a flowability, wherein the characteristic includes the flowability.

54. The method of claim 52, wherein determining the characteristic comprises a determining an amount of contamination, wherein the characteristic includes the amount of contamination.

55. The method of claim 52, wherein determining the characteristic comprises a determining a print history, wherein the characteristic includes the print history.

56. The method of claim 52, wherein determining the characteristic comprises a determining a print performance, wherein the characteristic includes the print performance.

57. The method of claim 49, wherein accepting the first powder into the first chamber comprises dosing the first metal powder into the first chamber.

58. The method of claim 49, further comprising transporting the first metal powder through the first chamber.

59. The method of claim 49, further comprising creating the first metal powder from one or more metal sources including recycled three-dimensional printed structures.

60. A method for a powder-bed fusion system, comprising:
accepting a metal powder from the powder-bed fusion system into a chamber, the chamber including a first port and a second port;
determining a characteristic of the metal powder;
determining whether to reuse the metal powder based on the characteristic; and
transporting the metal powder through the first port in response to the determination to reuse the metal powder and transporting the metal powder through the second port in response to the determination not to reuse the metal powder.

61. The method of claim 60, further comprising:
transporting the metal powder from the second port to a metal atomizer; and
heating the metal powder into a liquid metal and producing new metal powder from the liquid metal.

62. The method of claim 61, further comprising heating recycled three-dimensional printed structures into the liquid metal.

63. The method of claim 60, further comprising:
transporting the metal powder from the first port to a decontamination component; and
decontaminating the metal powder.

64. The method of claim 60, further comprising:
mixing the metal powder with new metal powder in a second chamber based on a ratio of metal powder to new metal powder.

65. A method for a powder-bed fusion system, comprising:
accepting a metal powder from the powder-bed fusion system into a chamber;
decontaminating the metal powder in the chamber; and
transporting the decontaminated metal powder out of the chamber.

66. The method of claim 65, further comprising heating the metal powder.

67. The method of claim 65, further comprising:
mixing the decontaminated metal powder with new metal powder in a second chamber based on a ratio of decontaminated metal powder to new metal powder.

68. The method of claim 67, further comprising creating the new metal powder from one or more metal sources including recycled three-dimensional printed structures.

69. An method for a powder-bed fusion (PBF) system, comprising:
creating three-dimensional printed structures by fusing metal powder; and
creating the metal powder from one or more metal sources including recycled three-dimensional printed structures.

70. The method of claim 69, wherein the one or more metal sources further includes recycle powder from the PBF apparatus.
